(19) United States
(12) Patent Application Publication
(10) Pub. No.: US 2023/0276382 A1
(43) Pub. Date: Aug. 31, 2023

(54) COMMUNICATION DEVICE, RADIO COMMUNICATION SYSTEM, AND SYNCHRONIZATION SIGNAL TRANSMISSION METHOD

(71) Applicant: Fujitsu Limited, Kawasaki-shi (JP)

(72) Inventor: TAKESHI AKUTAGAWA, Kawasaki (JP)

(73) Assignee: Fujitsu Limited, Kawasaki-shi (JP)

(21) Appl. No.: 17/979,840

(22) Filed: Nov. 3, 2022

(30) Foreign Application Priority Data
Feb. 25, 2022 (JP) 2022-028130

(51) Int. Cl. H04W 56/00; H04W 16/28

(52) U.S. Cl. CPC H04W 56/001; H04W 16/28

(57) ABSTRACT

A communication device includes a communication interface that communicates with a plurality of radio units, and a processor that is connected to the communication interface, wherein the processor executes a process of determining a maximum number of beams that indicates an upper limit of the number of beams formed by each of the plurality of radio units such that a sum total of the number of beams formed by the plurality of radio units is equal to or less than the number of synchronization signals that are able to be transmitted within a predetermined time unit, and notifying the plurality of radio units of the determined maximum number of beams.

### CROSS-REFERENCE TO RELATED APPLICATION

This application is based upon and claims the benefit of priority of the prior Japanese Patent Application No. 2022-028130, filed on Feb. 25, 2022, the entire contents of which are incorporated herein by reference.

### FIELD

The embodiment discussed herein is related to a communication device, a radio communication system, and a synchronization signal transmission method.

### BACKGROUND

In general, in a radio communication system, synchronization signals are sometimes transmitted and received in order to establish synchronization between transmission/reception devices. For example, in the fifth generation mobile communication system (5G), radio units (RU) that are wireless units constituting a base station device notify synchronization signals called SSB (SS/PBCH Block) in a predetermined period, and a user equipment (UE) that is a terminal device establishes synchronization with a RU located nearby by receiving the SSB. The SSB includes a synchronization signal (SS) and a physical broadcast channel (PBCH), and is repeatedly transmitted in a predetermined period by using radio transmission.

Furthermore, in 5G, for example, radio waves, such as millimeter waveband, at an ultra-high frequency band is used. The radio waves at the ultra-high frequency band have straightness characteristics and exhibits a propagation loss. Accordingly, in 5G, RUs are arranged in relatively high density, and, in some cases, each of the RUs forms a directional beam (hereinafter, simply referred to as a “beam”) and transmits a signal.

If the RUs perform beamforming, each of the RU transmits different SSBs by using beams in different directions. In other words, each of the RUs transmits SSBs each having an allocated unique index in each of the beams while sweeping the beams within a cell coverage. The UE is able to identify the beams on the basis of the indices of the received SSBs and select a beam that is suitable for communication from among the beams that are formed by the RU.

Patent Document 1: International Publication Pamphlet No. WO 2018/008212

Patent Document 2: Japanese National Publication of International Patent Application No. 2020-536404

Patent Document 3: Japanese National Publication of International Patent Application No. 2018-514994

### SUMMARY

According to an aspect of an embodiment, a communication device includes, a communication interface that communicates with a plurality of radio units, and a processor that is connected to the communication interface, wherein the processor executes a process. The process includes determining a maximum number of beams that indicates an upper limit of a number of beams formed by each of the plurality of radio units such that a sum total of the number of beams formed by the plurality of radio units is equal to or less than a number of synchronization signals that are able to be transmitted within a predetermined time unit, and notifying the plurality of radio units of the determined maximum number of beams.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram illustrating a configuration example of a radio communication system;

FIG. 2 is a block diagram of a configuration of a CU/DU;

FIG. 3 is a block diagram illustrating a configuration of a RU;

FIG. 4 is a sequence diagram illustrating a synchronization signal transmission method;

FIG. 5 is a diagram illustrating a specific example of a synchronization signal;

FIG. 6 is a flowchart illustrating a beam setting process; and

FIG. 7 is a diagram illustrating a specific example of a half width table.

### DESCRIPTION OF EMBODIMENTS

Incidentally, the SSBs transmitted by the RUs are also used for a cell search performed by the UE. In other words, by receiving the SSBs that are transmitted by each of the RUs for each of the beams, the UE is able to determine a cell and a beam that are used for communication.

However, in an environment in which the RUs are arranged in a high density manner, there is a problem in that the cell search is not completed until each of the plurality of RUs transmits the SSB, and thus, the start of communication is delayed. Specifically, each of the RUs transmits the SSB while switching beams within a time unit having a predetermined length of time that is called a SSB burst. The SSB burst is periodically arranged at intervals, so that each of the plurality of RUs transmits the SSB while switching the beams in each of the different SSB bursts. As a result, it is difficult for the UE to select a cell and a beam that is most suitable for communication until the UE receives all of the SSBs in a plurality of SSB bursts, and the radio communication between the UE and the RU is not started.

In this way, a cell and a beam that are used for the communication is not determined until all of the SSBs in the plurality of SSB bursts are received, so that a delay occurs in the start of communication performed by the UE.

Preferred embodiments will be explained with reference to accompanying drawings. Furthermore, the present invention is not limited to the embodiments.

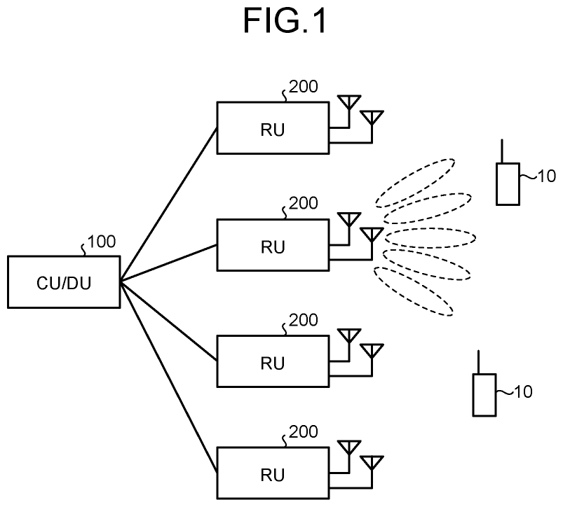

FIG. 1 is a diagram illustrating a configuration example of a radio communication system according to one embodiment. The radio communication system illustrated in FIG. 1 has a configuration in which a plurality of RUs 200 are connected to a central unit/distributed unit (CU/DU) 100, and constitutes, for example, a distributed antenna system (DAS).

The CU/DU 100 is a baseband device that constitutes a base station. The CU/DU 100 is connected to a core network that is not illustrated, and performs a baseband process with respect to a signal. Furthermore, the CU/DU 100 is connected to the plurality of RUs 200 via a front haul line, and manages beams formed by each of the plurality of RUs 200. In other words, the CU/DU 100 determines un upper limit of the number of beams that are formed by each of the RUs 200 (hereinafter, referred to as the “maximum number of beams”) in accordance with the number of RUs 200 that are connected to the CU/DU 100, and notifies each of the RUs 200 of information on the maximum number of beams (hereinafter, referred to as “maximum number of beam information”). A configuration and an operation of the CU/DU 100 will be described in detail later.

The RUs 200 are radio units that constitute a base station. Each of the RUs 200 is connected to the CU/DU 100 and performs a radio process on a signal. In other words, each of the RUs 200 transmits, by using radio transmission, a signal to a UE 10 that is present in a cell. Each of the RUs 200 sequentially forms a plurality of beams that are oriented in different directions within a cell coverage in order for the UE 10 to perform a cell search, and transmits, for example, a synchronization signal, such as a SSB, in each of the beams. At this time, each of the RUs 200 acquires the maximum number of beam information from the CU/DU 100, sequentially forms the beams up to the maximum number of beams, and transmits synchronization signals that are different for each of the beams. Furthermore, each of the RUs 200 transmits, in accordance with an instruction received from the CU/DU 100, a synchronization signal at a timing that is consecutive to the timing at which the other RU 200 transmits a synchronization signal. Therefore, the plurality of RUs 200 sequentially form beams within, for example, a consecutive single time unit, such as a single SSB burst, and transmit the synchronization signal.

The UE 10 is a terminal device that performs radio communication with the RU 200. When the UE 10 starts radio communication, the UE 10 receives a synchronization signal that is transmitted from each of the RUs 200, and performs a cell search in order to determine a cell that is used for communication performed on the basis of a reception level of each of the synchronization signals. At this time, the RUs 200 that constitute a cell transmit synchronization signals that are different for each of the beams, so that the UE 10 identifies the beams on the basis of the synchronization signals and selects a beam that is used for the communication.

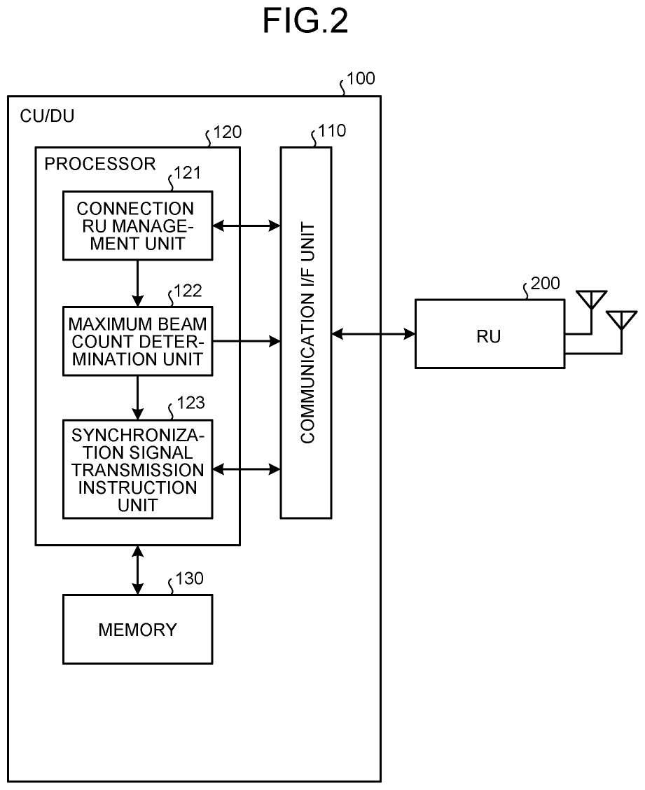

FIG. 2 is a block diagram illustrating a configuration of the CU/DU 100 according to one embodiment. The CU/DU 100 illustrated in FIG. 2 includes a communication interface unit (hereinafter, simply referred to as a “communication I/F unit”) 110, a processor 120, and a memory 130.

The communication I/F unit 110 includes an interface for communicating with each of the RUs 200. The communication I/F unit 110 receives identification information for identifying each of the RUs 200 from the respective RUs 200 that are connected to the CU/DU 100, transmits maximum number of beam information that indicates the maximum number of beams allocated to each of the RUs 200 to the RU 200, and the like.

The processor 120 includes, for example, a central processing unit (CPU), a field programmable gate array (FPGA), a digital signal processor (DSP), or the like, and performs overall control of the CU/DU 100. Specifically, the processor 120 includes a connection RU management unit 121, a maximum beam count determination unit 122, and a synchronization signal transmission instruction unit 123.

The connection RU management unit 121 manages the RUs 200 that are connected to the CU/DU 100. Specifically, the connection RU management unit 121 holds identification information on each of the plurality of RUs 200 that are connected to the communication I/F unit 110. Furthermore, the connection RU management unit 121 transmits a transmission request for the identification information from the communication I/F unit 110 to each of the RUs 200 at the time of, for example, the start of an operation of the radio communication system. Then, the connection RU management unit 121 collects pieces of identification information from each of the RUs 200 and holds the collected identification information.

The maximum beam count determination unit 122 determines the upper limit of the number of beams (the maximum number of beams) allocated to each of the RUs 200 on the basis of the identification information on each of the RUs 200 that are managed by the connection RU management unit 121. Specifically, the maximum beam count determination unit 122 determines the maximum number of beams to be allocated to each of the RUs 200 such that the sum total of the number of beams formed by the plurality of RUs 200 connected to the CU/DU 100 is equal to or less than the number of synchronization signals that are able to be transmitted within a single time unit that is used to transmit the synchronization signals.

In other words, the maximum beam count determination unit 122 stores therein, as a set value in advance, for example, 64 that is the number of SSBs that are able to be transmitted in a single SSB burst, and determines the maximum number of beams to be allocated to a single piece of the RU 200 by dividing the set value by, for example, the number of RUs 200 that are connected to the CU/DU 100. Therefore, for example, in the case where the four RUs 200 are connected to the CU/DU 100, the maximum beam count determination unit 122 determines that the maximum number of beams of each of the RUs 200 is 16 (=64/4).

Then, the maximum beam count determination unit 122 generates the maximum number of beam information that indicates the maximum number of beams for each of the determined RUs 200, and transmits the generated information from the communication I/F unit 110 to each of the RUs 200.

The synchronization signal transmission instruction unit 123 instructs the plurality of RUs 200 that are connected to the CU/DU 100 to transmit a synchronization signal. Specifically, the synchronization signal transmission instruction unit 123 instructs a transmission timing of the synchronization signal of each of the RUs 200 such that each of the plurality of RUs 200 consecutively transmits the synchronization signal within a single time unit. In other words, for example, the synchronization signal transmission instruction unit 123 instructs a first RU 200 to start transmission of a synchronization signal from the SSB burst located at the top, and instructs a second RU 200 to start transmission of a synchronization signal immediately after the completion of the transmission of the synchronization signal performed by the first RU 200. Each of the RUs 200 starts transmission of the synchronization signal at the instructed timing, sequentially forms beams up to the maximum number of beams, and transmits the synchronization signal that is different for each of the beams.

The memory 130 includes, for example, a random access memory (RAM), a read only memory (ROM), or the like, and stores information that is used for a process performed by the processor 120.

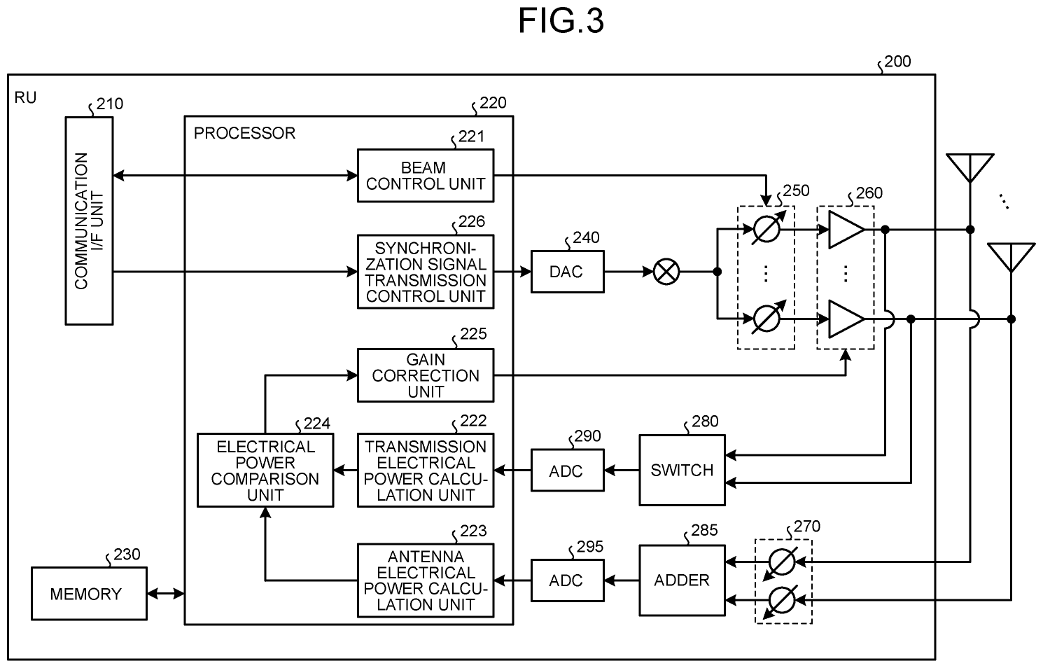

FIG. 3 is a block diagram illustrating a configuration of the RU 200 according to one embodiment. The RU 200 illustrated in FIG. 3 includes a communication I/F unit 210, a processor 220, a memory 230, a digital analog converter (DAC) 240, a phase shifter 250, a power amplifiers 260, a phase detector 270, a switch 280, an adder 285, and analog digital converters (ADCs) 290 and 295.

The communication I/F unit 210 includes an interface for performing communication with the CU/DU 100. The communication I/F unit 210 transmits identification information on the own RU 200 to the CU/DU 100, receives the maximum number of beam information that indicates the maximum number of beams allocated to the own RU 200 from the CU/DU 100, and the like.

The processor 220 includes, for example, a CPU, an FPGA, a DSP, or the like and performs overall control of the RU 200. Specifically, the processor 220 includes a beam control unit 221, a transmission electrical power calculation unit 222, an antenna electrical power calculation unit 223, an electrical power comparison unit 224, a gain correction unit 225, and a synchronization signal transmission control unit 226.

The beam control unit 221 acquires the maximum number of beam information from the communication I/F unit 210, and determines the beams to be formed such that the number of beams is equal to or less than the maximum number of beams. Specifically, the beam control unit 221 determines the width and the direction of the beam such that the sum total of the number of beams needed to cover the entirety of the cell that is formed by the RUs 200 is equal to or less than the maximum number of beams. Then, the beam control unit 221 sets, to the phase shifter 250, an amount of phase shift for forming the beam having the determined width and the determined direction. If the setting related to the beam has been completed, the beam control unit 221 transmits a setting completion notification from the communication I/F unit 210 to the CU/DU 100.

The transmission electrical power calculation unit 222 calculates transmission electrical power by using a feedback signal that is fed back from the output stage of the power amplifier 260. The transmission electrical power calculated by the transmission electrical power calculation unit 222 is electrical power that is in accordance with a gain of the power amplifier 260.

The antenna electrical power calculation unit 223 calculates antenna electrical power by using a feedback signal that is fed back from each of the antenna elements. The antenna electrical power calculated by the antenna electrical power calculation unit 223 is electrical power that is in accordance with a beam gain that is obtained by a beam.

The electrical power comparison unit 224 performs electrical power comparison in order to compare transmission electrical power and antenna electrical power to predetermined target electrical power. In other words, the electrical power comparison unit 224 determines whether or not the predetermined target electrical power is output by the transmission electrical power and the antenna electrical power, and, if it is determined that the predetermined target electrical power is not output, the electrical power comparison unit 224 calculates an electrical power offset that indicates insufficient electrical power or excessive electrical power. Then, the electrical power comparison unit 224 notifies the gain correction unit 225 of the calculated electrical power offset.

If the gain correction unit 225 receives the notification of the electrical power offset, the gain correction unit 225 corrects the gain of the power amplifier 260 in accordance with the electrical power offset. In other words, if the output electrical power is insufficient, the gain correction unit 225 causes the gain of the power amplifier 260 to be increased in accordance with the insufficient electrical power, whereas, if the output electrical power exceeds, the gain correction unit 225 causes the gain of the power amplifier 260 to be decreased in accordance with the excessive electrical power.

The synchronization signal transmission control unit 226 generates and transmits a synchronization signal, such as a SSB, in accordance with the transmission instruction related to the synchronization signal received from the CU/DU 100. In other words, the synchronization signal transmission control unit 226 transmits synchronization signals that are different for each of the plurality of beams that are sequentially formed by the beam control unit 221.

The memory 230 includes, for example, a RAM, a ROM, or the like and stores information that is used for a process performed by the processor 220.

The DAC 240 performs DA conversion on the synchronization signal that is output from the synchronization signal transmission control unit 226. The synchronization signal that has been subjected to DA conversion by the DAC 240 is subjected to up-conversion to a radio frequency, and then, distributed to each of the plurality of antenna elements.

The phase shifter 250 includes a plurality of phase shifters that are provided in association with a plurality of antenna elements and shifts the phase of an input signal in accordance with control performed by the beam control unit 221. In other words, the phase shifter 250 sets a phase difference to the synchronization signal that is transmitted from each of the antenna elements as a result of the beam control unit 221 setting an amount of phase shift that is associated with each of the antenna elements, so that the phase shifter 250 allows the synchronization signal to be transmitted in the direction of the beam.

The power amplifier 260 includes a plurality of power amplifiers that are provided in association with the plurality of antenna elements and amplifies the input signal. The power amplifier 260 amplifies a synchronization signal for each of, for example, the antenna elements. At this time, the power amplifier 260 increases and decreases the gain in accordance with an instruction received from the gain correction unit 225, and amplifies the signal that is transmitted from each of the antenna elements. The signal that is output from the power amplifier 260 is transmitted from the antenna element by using radio transmission, and is fed back to the switch 280.

The phase detector 270 allows the signal that is transmitted from each of the antenna elements by using radio transmission to be fed back and detects the phase of each of the signals. The phase detected by the phase detector 270 is the phase that is in accordance with an amount of phase shift that is set in the phase shifter 250.

The switch 280 allows the signal to be fed back from the output stage of the power amplifier 260, and sequentially outputs the feedback signals associated with the respective antenna elements to the ADC 290.

The adder 285 adds the phase that is detected, by the phase detector 270, for each of the antenna elements. In other words, by calculating a phase difference between the signals transmitted from the respective antenna elements, the adder 285 acquires the feedback signal that indicates the beam gain that is obtained by forming a beam.

The ADC 290 performs AD conversion on the feedback signal that is output from the switch 280, and outputs the converted signal to the transmission electrical power calculation unit 222.

The ADC 295 performs AD conversion on the feedback signal that is output from the adder 285, and outputs the converted signal to the antenna electrical power calculation unit 223.

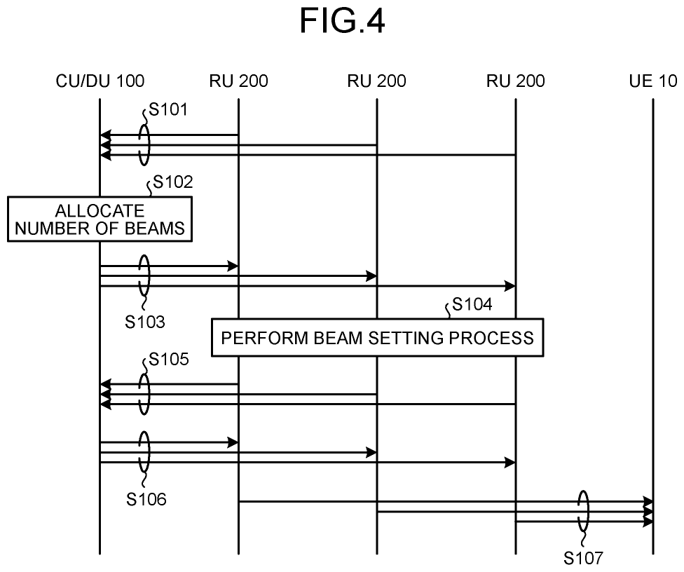

In the following, a synchronization signal transmission method that is used in the radio communication system that has been configured as described above will be described with reference to the sequence diagram illustrated in FIG. 4. Here, a synchronization signal transmission method that is used in a case of a start of an operation of the radio communication system in which the plurality of RUs 200 are connected to the CU/DU 100 will be described.

At the time of the start of an operation of the radio communication system, for example, as a result of a notification request for the identification information being transmitted from the CU/DU 100 to each of the RUs 200, each of the RUs 200 transmits the identification information associated with the respective own RUs 200 to the CU/DU 100 (Step S101). The identification information on each of the RUs 200 is received by the communication I/F unit 110 included in the CU/DU 100 and is held by the connection RU management unit 121.

Then, a set value that indicates the number of synchronization signals that are able to be transmitted within a single time unit is divided by the number of connected RUs 200 by the maximum beam count determination unit 122, and the maximum number of beams is allocated to each of the RUs 200 (Step S102). For example, it is possible to transmit 64 SSBs in a SSB burst that is a single time unit, so that the maximum number of beams that is allocated to a single piece of the RU 200 is determined by dividing 64 by the number of RUs 200. As a result of the maximum number of beams being determined in this way, each of the RUs 200 forms beams up to the maximum number of beams and transmits the synchronization signal for each of the beams, so that transmission of the synchronization signals performed by all of the RUs 200 is completed within a single time unit.

Furthermore, here, it is assumed that the set value is divided by the number of RUs 200, and the number of beams is equally allocated to each of the RUs 200; however, the allocation of the number of beams need not to be equal. In other words, for example, the number of beams may be allocated to each of the RUs 200 in accordance with the magnitude of the cell coverage of the RUs 200. In this case, for example, it may be possible to allocate, as the maximum number of beams, a greater number of beams to the RU 200 as the cell coverage is increased.

If the maximum number of beams for each of the RUs 200 is determined, the maximum number of beam information is transmitted from the communication I/F unit 110 to each of the RUs 200 (Step S103). The maximum number of beam information is received by the communication I/F unit 210 included in each of the RUs 200, and is acquired by the beam control unit 221. Then, a beam setting process of covering the cell associated with the RUs 200 and forming the beams up to the maximum number of beams is performed by the beam control unit 221 (Step S104). In the beam setting process, the width and the direction of each of the beams are determined such that the number of beams is equal to or less than the maximum number of beams, an amount of phase shift for forming each of the beams is set to the phase shifter 250, and the gain of the power amplifier 260 is corrected. Furthermore, the beam setting process will be described in detail later.

If the beam setting process performed in each of the RU 200 has been completed, a setting completion notification is transmitted from the communication I/F unit 210 included in each of the RUs 200 to the CU/DU 100 (Step S105). If the setting completion notification is received by the communication I/F unit 110 included in the CU/DU 100, the transmission timing of the synchronization signal transmitted by each of the RUs 200 is instructed by the synchronization signal transmission instruction unit 123 (Step S106). Specifically, for example, within a single time unit, such as a SSB burst, an instruction indicating that each of the RUs 200 transmits a synchronization signal while sequentially forming beams is given to each of the RUs 200.

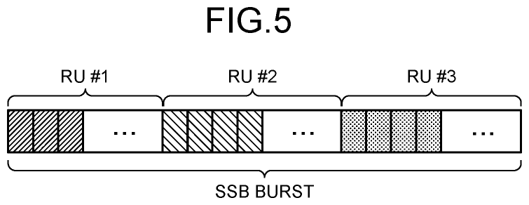

If the instruction received from the synchronization signal transmission instruction unit 123 is received by the communication I/F unit 210 that is included in the RU 200, a synchronization signal that is different for each of the beams is generated by the synchronization signal transmission control unit 226, each of the beams is sequentially formed, and the synchronization signals are transmitted (Step S107). The plurality of RUs 200 sequentially form beams and transmits the synchronization signals for each of the beams within, for example, a single time unit, such as a SSB burst. In other words, for example, as illustrated in FIG. 5, in a single SSB burst, if a RU #1 firstly forms beams up to the maximum number of beams and transmits synchronization signals, a RU #2 subsequently forms beams up to the maximum number of beams and transmits synchronization signals, and furthermore, a RU #3 forms beams up to the maximum number of beams and transmits synchronization signals.

In this way, the plurality of RUs 200 transmit the synchronization signals within a single time unit, so that the UE 10 is able to receive all of the synchronization signals transmitted from the plurality of RUs 200 within this time unit. As a result, the UE 10 is able to measure communication quality of the synchronization signals and determine, in an early stage, the cell and the beam that are used for the communication. In other words, it is possible to reduce a delay of the start of communication performed by the UE 10.

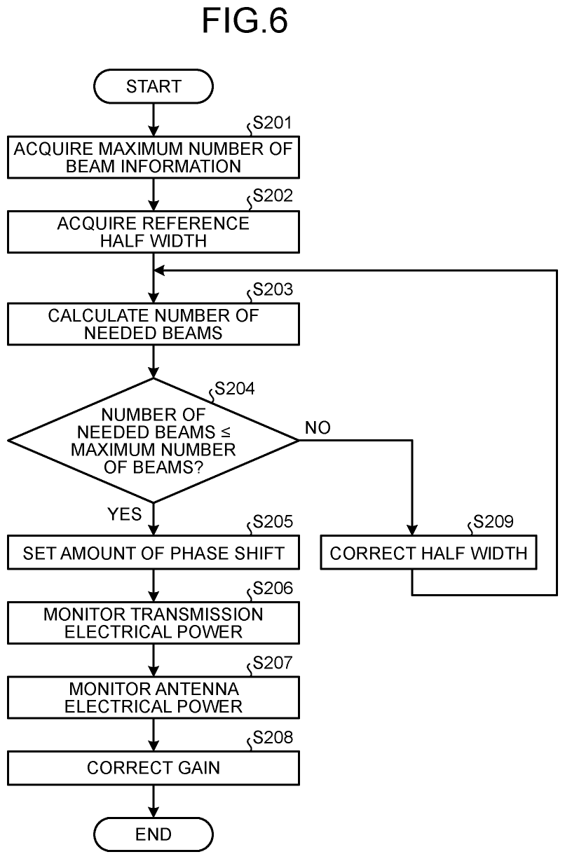

In the following, a beam setting process performed by the RU 200 will be specifically described with reference to the flowchart illustrated in FIG. 6. The beam setting process is performed by the RU 200 that has received the maximum number of beam information from the CU/DU 100.

If the maximum number of beam information is received by the communication I/F unit 210, the maximum number of beam information is acquired by the beam control unit 221 (Step S201). Furthermore, a half width of the beam associated with the number of antenna elements included in the RU 200 is acquired by the beam control unit 221 (Step S202). In other words, the half width that indicates an angle of the beam up to a position at which the beam gain decreases by 3 dB from the maximum gain is defined on the basis of the number of antenna elements included in the RU 200, so that the half width that is associated with the number of antenna elements is acquired as a reference half width.

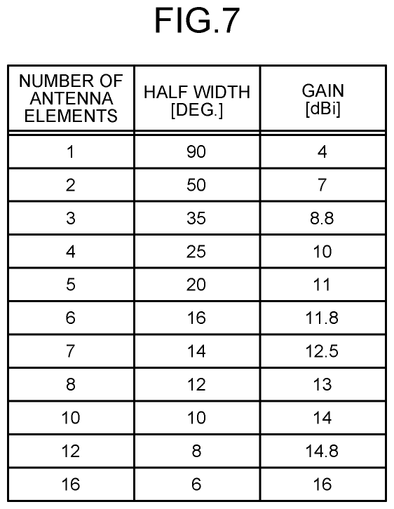

The reference half width may be calculated from, for example, the number of antenna elements by using a calculation formula of the array factor, or may be calculated from a half width table that indicates the relationship between the number of antenna elements and the half width. FIG. 7 is a diagram illustrating a specific example of the half width table. As illustrated in FIG. 7, the half width table stores therein, in an associated manner, the number of antenna elements, a half width, and a beam gain. For example, in the case where the RU 200 includes four antenna elements, it is found that the reference half width is 25 degrees and the beam gain is 10 dBi from the half width table illustrated in FIG. 7.

If the maximum number of beams and the reference half width are acquired, the number of needed beams that are needed to cover the cell associated with the RUs 200 is calculated (Step S203). Specifically, if an area coverage of the cell in the horizontal direction and in the vertical direction is covered by the beams with the reference half width, the number of beams that are needed in the horizontal direction and the vertical direction is calculated. For example, in the case where the area coverage of the cell in each of the horizontal direction and the vertical direction is 90 degrees, if the reference half width of the beam is 25 degrees, it is possible to cover the cell in the horizontal direction by four beams and cover the cell in the vertical direction by four beams. As a result, the number of needed beams that are needed to cover the cell is calculated to be 16 (=4×4).

If the number of needed beams is calculated, it is determined whether or not the number of needed beams is equal to or less than the maximum number of beams (Step S204). If the determination result indicates that the number of needed beams is greater than the maximum number of beams (No at Step S204), correction is performed such that the half width is increased by a predetermined width (Step S209), and the number of needed beams is again calculated by using the corrected half width (Step S203).

As described above, the half width is allowed to be increased by each of predetermined widths until the number of needed beams reaches equal to or less than the maximum number of beams, and, if the number of needed beams reaches equal to or less than the maximum number of beams (Yes at Step S204), an amount of phase shift that is used to form each of the beams each having the half width and the direction at this time is set to the phase shifter 250 (Step S205). In other words, an amount of phase shift that is used to form each of the beams, the number of which is equal to or less than the maximum number of beams, that covers the cell associated with the RUs 200 is set to the phase shifter 250.

Then, in the state in which the amount of phase shift is set to the phase shifter 250, the signal that is output from the power amplifier 260 is fed back by the switch 280, and the transmission electrical power is monitored by the transmission electrical power calculation unit 222 (Step S206). In other words, electrical power that is in accordance with the gain of the power amplifier 260 is monitored.

Furthermore, a phase is detected, by the phase detector 270, from the signal that is transmitted using radio transmission by each of the antenna elements, and then, the detected phases are combined by the adder 285, so that a feedback signal indicating beam electrical power is acquired. Then, the antenna electrical power based on the feedback signal is monitored by the antenna electrical power calculation unit 223 (Step S207). In other words, the electrical power that is in accordance with the beam gain is monitored.

Then, the output electrical power that is in accordance with the monitored transmission electrical power and the antenna electrical power is compared to predetermined target electrical power, electrical power offset that indicates insufficient electrical power or excessive electrical power is calculated, and the gain of the power amplifier 260 is corrected in accordance with the electrical power offset (Step S208). In other words, if the output electrical power is insufficient, the transmission electrical power is allowed to be increased by increasing the gain of the power amplifier 260, whereas, if the output electrical power exceeds, the transmission electrical power is allowed to be decreased by decreasing the gain of the power amplifier 260.

In this way, as a result of the amount of phase shift being set to the phase shifter 250 and the gain of the power amplifier 260 being corrected, the beam setting process performed in the RU 200 is completed, so that the setting completion notification is transmitted to the CU/DU 100. Then, the RU 200 sequentially forms a plurality of beams, in accordance with an instruction received from the CU/DU 100, on the basis of the amount of phase shift that is set to the phase shifter 250 and transmits a synchronization signal by using each of the beams.

As described above, according to the present embodiment, the CU/DU determines the maximum number of beams that is allocated to each of the plurality of RUs such that transmission of the synchronization signals performed by all of the RUs is completed within a single time unit, and each of the RUs performs setting to form beams such that the number of beams is equal to or less than the maximum number of beams. Then, the plurality of RUs sequentially form beams in accordance with the instruction received from the CU/DU within the single time unit, and transmit the synchronization signals that are different for each of the beams. As a result, the UE is able to select a cell and a beam that are used for communication by receiving the synchronization signals within the single time unit, and is able to reduce a delay of the start of the communication.

According to an aspect of an embodiment of the communication device, the radio communication system, and the synchronization signal transmission method disclosed in the present disclosure, an advantage is provided in that it is possible to reduce a delay of the start of communication.

All examples and conditional language recited herein are intended for pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although the embodiments of the present disclosure have been described in detail, it should be understood that the various changes, substitutions, and alterations could be made hereto without departing from the spirit and scope of the disclosure.

What is claimed is:

1. A communication device comprising:
a communication interface that communicates with a plurality of radio units; and
a processor that is connected to the communication interface, wherein the processor executes a process including:
determining a maximum number of beams that indicates an upper limit of a number of beams formed by each of the plurality of radio units such that a sum total of the number of beams formed by the plurality of radio units is equal to or less than a number of synchronization signals that are able to be transmitted within a predetermined time unit; and
notifying the plurality of radio units of the determined maximum number of beams.

2. The communication device according to claim 1, wherein the process further includes collecting identification information on the plurality of radio units.

3. The communication device according to claim 1, wherein the determining includes determining the maximum number of beams by dividing the number of synchronization signals by the number of plurality of radio units.

4. The communication device according to claim 1, wherein the process further includes instructing the plurality of radio units to sequentially transmit the synchronization signals for each of the beams within the predetermined time unit.

5. A communication device comprising:
a plurality of antenna elements;
a plurality of power amplifiers that are provided in association with the plurality of antenna elements;
a plurality of phase shifters that are provided in association with the plurality of antenna elements; and
a processor that controls the plurality of power amplifiers and the plurality of phase shifters, wherein the processor executes a process including:
acquiring maximum number of beam information that indicates the maximum number of beams formed by the own device;
determining a width and a direction of each of the beams such that a number of beams that covers a cell is equal to or less than the maximum number of beams;
setting, to each of the phase shifters, an amount of phase shift for forming a beam having the determined width and the determined direction; and
transmitting synchronization signals that are different for each of the beams formed by the respective phase shifters.

6. The communication device according to claim 5, wherein the process further includes correcting a gain of each of the power amplifiers in accordance with a beam gain that is obtained by the beam having the determined width.

7. A radio communication system comprising:
a plurality of radio units; and
a communication control device that is connected to the plurality of radio units, wherein
the communication control device includes
a communication interface that communicates with the plurality of radio units, and
a processor that is connected to the communication interface, wherein the processor executes a process including:
determining a maximum number of beams that indicates an upper limit of a number of beams formed by each of the plurality of radio units such that a sum total of the number of beams formed by the plurality of radio units is equal to or less than a number of synchronization signals that are able to be transmitted within a predetermined time unit; and
notifying the plurality of radio units of the determined maximum number of beams.

8. A synchronization signal transmission method comprising:
determining a maximum number of beams that indicates an upper limit of a number of beams formed by each of a plurality of radio units such that a sum total of the number of beams formed by the plurality of radio units is equal to or less than a number of synchronization signals that are able to be transmitted within a predetermined time unit, the plurality of radio units including a plurality of antenna elements and a plurality of phase shifters that are associated with the plurality of respective antenna elements;
determining a width and a direction of each of the beams such that the number of beams that covers a cell associated with each of the plurality of radio units is equal to or less than the maximum number of beams;
setting, to each of the phase shifters, an amount of phase shift for forming a beam having the determined width and the determined direction; and
transmitting synchronization signals that are different for each of the beams formed by the respective phase shifters, using a processor.
